(19) United States
(12) Patent Application Publication
(10) Pub. No.: US 2021/0172219 A1
(43) Pub. Date: Jun. 10, 2021

(54) DOOR HANDLE ASSEMBLY OF A VEHICLE DOOR

(71) Applicant: HUF HÜELSBECK & FÜERST GMBH & CO. KG, Velbert (DE)

(72) Inventors: Christian Bresser, Leichlingen (DE); Michael Rhein, Moenchengladbach (DE); Bernd Reifenberg, Essen (DE)

(73) Assignee: Huf Huelsbeck & Fuerst GmbH & Co. KG, Velbert (DE)

(21) Appl. No.: 16/771,594

(22) PCT Filed: Oct. 19, 2018
(86) PCT No.: PCT/EP2018/078694

§ 371 Date: Jun. 10, 2020

(30) Foreign Application Priority Data
Dec. 14, 2017 (DE) 10 2017 130 030.9

(51) Int. Cl. E05B 85/10; E05B 81/76

(52) U.S. Cl. CPC E05B 85/107; E05Y 2900/531; E05B 81/76

(57) ABSTRACT

A door handle assembly of a vehicle door includes a handle support, a handle which is designed to be movable into a non-use position and an actuation position, a first lifting mechanism and a second lifting mechanism, each of which is coupled to the handle. The handle protrudes relative to the outer contour of the vehicle door in the actuation position. The first lifting mechanism has a first pivot axis which is arranged on the handle support. The second lifting mechanism has a second joint axis which is coupled to the first lifting mechanism so as to transmit a movement. The first lifting mechanism and the second lifting mechanism are coupled together in the form of a multi-joint kinematic system so as to transmit a movement. The first longitudinal end and the second longitudinal end of the handle are designed to move out of the outer contour simultaneously.

The invention relates to a door handle assembly of a vehicle door, having a handle support which can be secured to the vehicle door, a handle being mounted on the handle support and arranged so as to run flush with the outer contour of the vehicle door in a non-use position and being designed to be movable into an actuation position by a user for actuation, and a first lever mechanism which is arranged on the first longitudinal end of the handle, and a second lever mechanism which is coupled to the second longitudinal end of the handle so as to transmit a movement, wherein the handle is arranged so as to protrude relative to the outer contour of the vehicle door in the actuation position in comparison to the non-use position and can be actuated by the user in order to open the vehicle door, and wherein the first lever mechanism has a first pivot axis which is arranged on the handle support.

Door handle assemblies in which the handle extends flush with the outer contour of the vehicle door in its non-use position are known from the prior art. The handle may thereby be designed as an inner or outer handle in the case of these types of door handle assemblies for a vehicle door of a motor vehicle, wherein the present invention relates to a door handle assembly for an outer handle. For this type of door handle assembly, there is a variety of different constructions and embodiments. The door handle assembly according to the invention relates to such constructions in which a handle support is secured to the rear of the vehicle door, i.e. inside the motor vehicle. In such embodiments, the handle attached to the handle support usually protrudes from the vehicle door and disturbs both the aesthetic impression of the vehicle and the vehicle aerodynamics. In order to avoid these disadvantages, there are known prior art door handle assemblies in which the outside of the handle in its non-use position, i.e. in which it is not used, extends approximately flush with the outer contour of the vehicle door, i.e. flush with the edge. Such a handle can be transferred to an actuation position for opening the vehicle door or an on-board lock, in which the handle protrudes compared to the outer contour of the vehicle door. The handle is extended using a motor when a legitimate user approaches the vehicle. Once the handle is no longer needed, it returns to the non-use position and disappears into the vehicle body to avoid producing air resistance. As is known, the movement of the handle is realized with the aid of a first lever mechanism and a second lever mechanism, which couple the respective longitudinal ends of the handle to the handle support. A disadvantage of such door handle assemblies of the type described at the outset is the limited installation space, since the overall depth of the door, i.e. the extension from the outside of the door to the inside of the door, generally also has to take into account the depth which is required so that the window pane can be guided past the handle support when it is opened and the lever mechanism does not get into the movement path of the window pane during a movement of the handle from the non-use position into the actuation position. The depth for countersinking the window pane can hardly be reduced, so that the installation depth of the door handle assembly decisively determines the overall depth of the door.

The invention has for its object to develop a door handle assembly of a vehicle door in a structurally simple and inexpensive manner, which has a small installation depth and through which the overall depth of the door can be reduced.

In a door handle assembly of the type described in the introduction, this object is achieved according to the invention in that the second lever mechanism has a second pivot axis which is coupled to the first lever mechanism so as to transmit a movement, wherein the first lever mechanism and the second lever mechanism are designed to be coupled to one another in the manner of a multi-joint kinematic system so as to transmit a movement, and the first longitudinal end and the second longitudinal end of the handle are designed to simultaneously extend out of the outer contour.

Advantageous and expedient embodiments and developments of the invention are disclosed in the dependent claims.

The invention provides a door handle assembly in a structurally simple and inexpensive manner, by means of which the overall depth of the door can be reduced to a minimum. Because the first lever mechanism and the second lever mechanism are coupled together so as to transmit a movement according to a multi-joint kinematic system, it is possible to accommodate the required kinematic processes in the smallest and tightest installation space, which are necessary for moving the handle from the non-use position to the actuation position and back to the non-use position. The multi-joint kinematic system formed by the first lever mechanism and the second lever mechanism increase the efficiency of the door handle assembly according to the invention, because this design has a high degree of rigidity with increased acceleration values for the movement of the handle in comparison to known door handle assemblies, wherein the movement of the door handle arrangement according to the invention takes place at a high level of accuracy.

In one embodiment, the invention provides that the first lever mechanism has a first joint axis which is arranged at the first longitudinal end of the handle and which is coupled to the first pivot axis so as to transmit a movement, wherein the second lever mechanism has a second pivot axis which is arranged on the handle support, and a joint axis, which is arranged at the second longitudinal end of the handle, and wherein the first pivot axis is motor-driven to move the handle. The first pivot axis of the first lever kinematic system consequently also drives the second lever kinematic system coupled to it.

In an embodiment of the invention, it is structurally particularly favorable if the first lever mechanism has a lever element having a point of rotation with a first lever arm and a second lever arm, wherein the lever element is designed to be coupled both to the first pivot axis and to the first joint axis so as to transmit a movement.

According to a first embodiment of the invention, it is provided that the first lever mechanism further comprises a movement lever mounted on the first pivot axis and a guide lever, wherein the guide lever is mounted on a third pivot axis which is arranged on the handle support, wherein the third pivot axis is offset from the first pivot axis in an opening direction of the handle, and wherein the movement lever and the guide lever are arranged to be offset parallel to one another such that the guide lever is connected in an articulated manner to the first lever arm and the movement lever is connected in an articulated manner to the point of rotation.

In an embodiment of the first embodiment, it is particularly advantageous if the first lever arm and the second lever arm are arranged at the point of rotation at an acute angle to one another, wherein the second lever arm interconnects the point of rotation and the first joint axis.

To couple the first lever mechanism to the second lever mechanism so as to transmit a movement, it is provided in an embodiment of the first embodiment that a coupling rod couples the first joint axis to the second joint axis so as to transmit a movement, wherein an active lever couples the second joint axis to the second pivot axis.

With regard to a small installation space, the invention provides in a further embodiment of the first embodiment that the movement lever is pivoted in the opening direction and thereby the movement lever, the lever element, and the coupling rod press the second joint axis in the opening direction to move the handle from the non-use position into the actuation position.

In a configuration of a second embodiment, the invention provides that the first lever arm is coupled to the first pivot axis and a coupling rod is rotatably mounted on the second lever arm, which is connected to the second joint axis in an articulated manner, wherein a coupling element is provided which is rotatably mounted on the point of rotation and which has a first coupling arm which is rotatably connected to the first joint axis and a second coupling arm, which is coupled to the second pivot axis so as to transmit a movement.

In a design of the second embodiment, it is advantageous for a small installation depth if a pivot lever mounted rotatably on the second pivot axis interconnects the second pivot axis and the second coupling arm.

In an embodiment of the second embodiment it is further provided that the lever element and the coupling element can be pivoted relative to one another. With this configuration, the installation space required for the first and second lever kinematics can be further reduced.

Furthermore, the installation space is reduced if the first lever arm is longer than the second lever arm, wherein the first coupling arm is designed to be longer than the second lever arm and the second coupling arm is designed to be longer than the first lever arm.

In an alternative embodiment, it is also conceivable that the first lever arm and the second lever arm are of equal length, wherein the first coupling arm is designed to be shorter than the first lever arm and the second coupling arm is designed to be longer than the first lever arm.

For a third embodiment, the invention provides that the lever element is mounted on the first pivot axis with its point of rotation, wherein the first lever arm is connected to the first joint axis in an articulated manner and the second lever mechanism comprises a pivot lever element having a first pivot lever arm which is connected to the second joint axis and a second pivot lever arm which is connected to the second lever arm via a first coupling rod in an articulated manner.

In an embodiment of the third embodiment, it is advantageous if the first joint axis is connected to the second joint axis via a second coupling rod in an articulated manner, wherein the lever element of the first lever mechanism and the pivot lever element of the second lever mechanism are of identical design, such that the first lever arm has an identical length as the first pivot lever arm and the second lever arm has an identical length as the second pivot lever arm.

For a small installation depth in the third embodiment, it is advantageous if the pivoting direction of the lever element about the first pivot axis is the same as that of the pivot lever element about the second pivot axis when the handle is moved from the non-use position into the actuation position.

According to a fourth embodiment of the invention, it is provided that the first lever mechanism has a third pivot axis, on which a guide lever is pivotably mounted, which in turn is connected in an articulated manner to a connecting lever fastened to the handle, wherein the guide lever couples the third pivot axis to the first joint axis and the connecting lever couples the guide lever and a movement lever which is pivotally mounted on the first pivot axis.

Finally, in an embodiment of the fourth embodiment, the invention provides that the second lever mechanism has a first coupling lever, which is mounted on the second pivot axis, and a second coupling lever, which is mounted on the second joint axis, wherein the first coupling lever and the second coupling lever are interconnected in an articulated manner at a joint point which is connected to the connecting lever via a coupling rod.

In the sense of the invention, an acute angle means an angle of less than 90°, whereas an obtuse angle means an angle between 90° and 180° in the sense of the invention.

It is self-evident that the features mentioned above and yet to be described below can be used not only in the combination described but also in other combinations or in isolation without departing from the scope of the present invention. The scope of the invention is defined only by the claims.

Other details, features, and advantages of the subject matter of the invention can be found in the following description in connection with the drawing, in which preferred embodiments of the invention are presented by way of example. In the drawings:

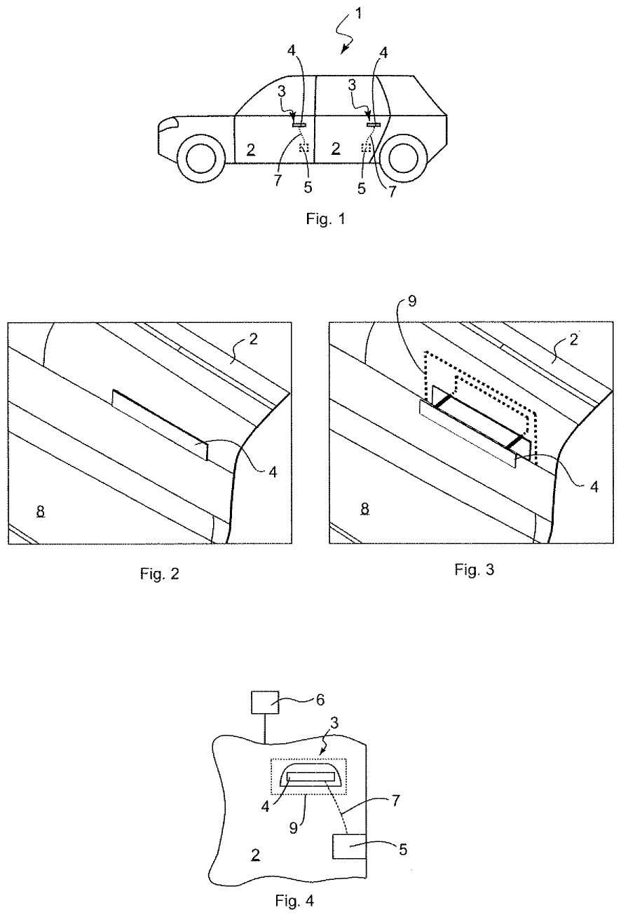

FIG. 1 is a side view of a motor vehicle having a door handle assembly according to the invention,

FIG. 2 shows a perspective view of a vehicle door of the motor vehicle, in which a handle of the door handle assembly according to the invention is arranged flush with an outer contour of the vehicle door in a non-use position,

FIG. 3 shows a perspective view of the vehicle door of the motor vehicle, in which the handle of the door handle assembly according to the invention is arranged in an actuation position in which the handle is displaced parallel to the non-use position and protrudes with respect to the outer contour of the vehicle door,

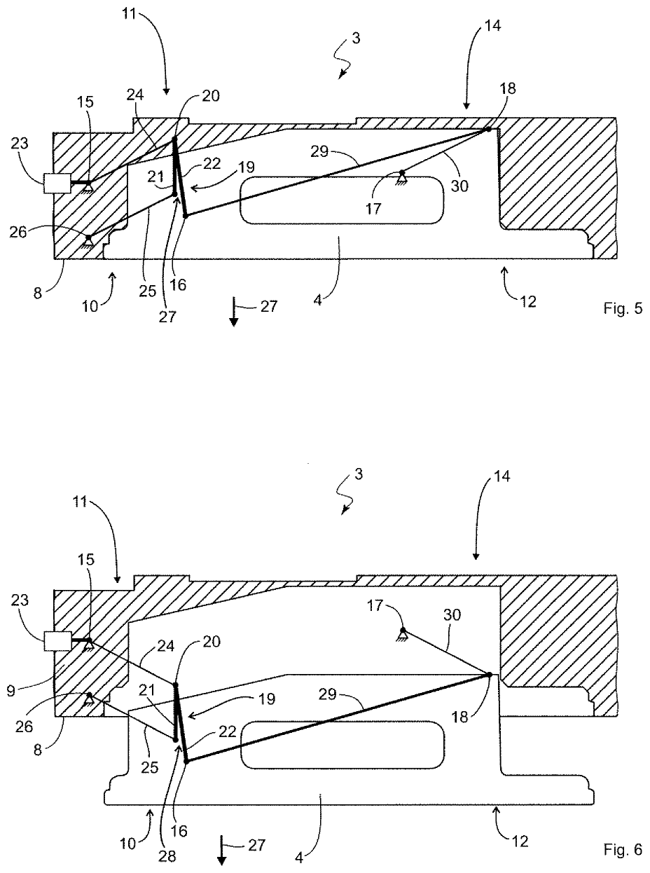

FIG. 4 is a schematic illustration of the vehicle door having the door handle assembly arranged thereon, a door lock, and a locking system,

FIG. 5 is a schematic top view of a door handle assembly according to a first embodiment of the invention, in which the handle is arranged in the non-use position,

FIG. 6 is a schematic top view of the door handle assembly according to the first embodiment of the invention, in which the handle is arranged in the actuation position,

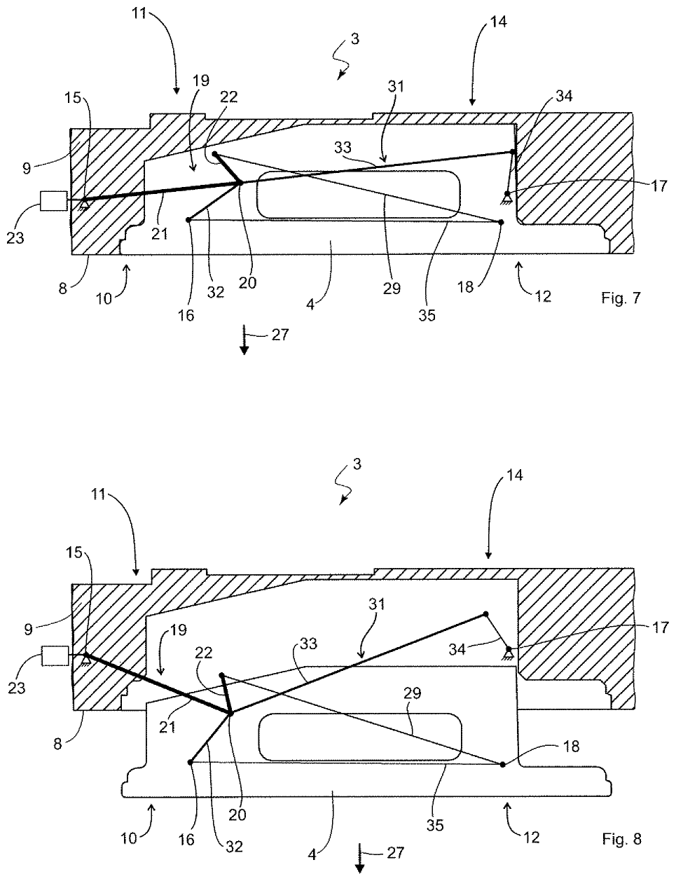

FIG. 7 is a schematic top view of a door handle assembly according to a second embodiment of the invention, in which the handle is arranged in the non-use position,

FIG. 8 shows a schematic top view of the door handle assembly according to the second embodiment of the invention, in which the handle is arranged in the actuation position,

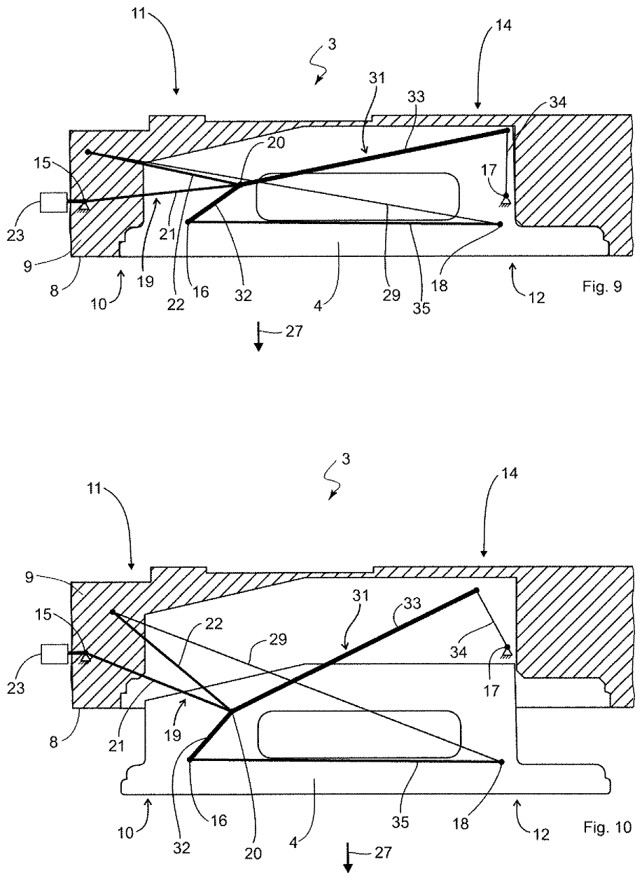

FIG. 9 is a schematic top view of a door handle assembly according to an alternative for the second embodiment of the invention, in which the handle is arranged in the non-use position,

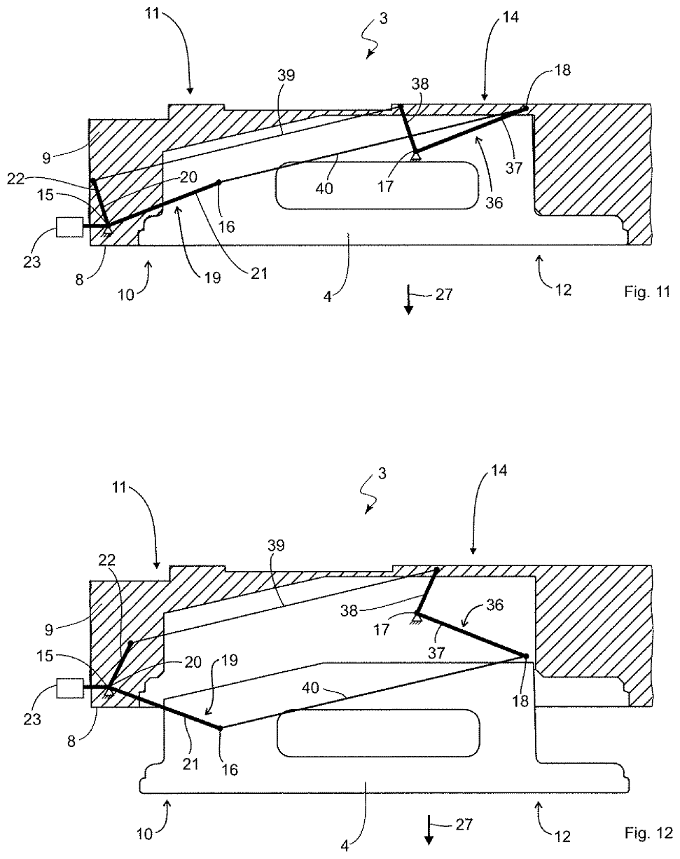

FIG. 10 shows a schematic top view of the door handle assembly according to the alternative for the second embodiment of the invention, in which the handle is arranged in the actuation position,

FIG. 11 is a schematic top view of a door handle assembly according to a third embodiment of the invention, in which the handle is arranged in the non-use position,

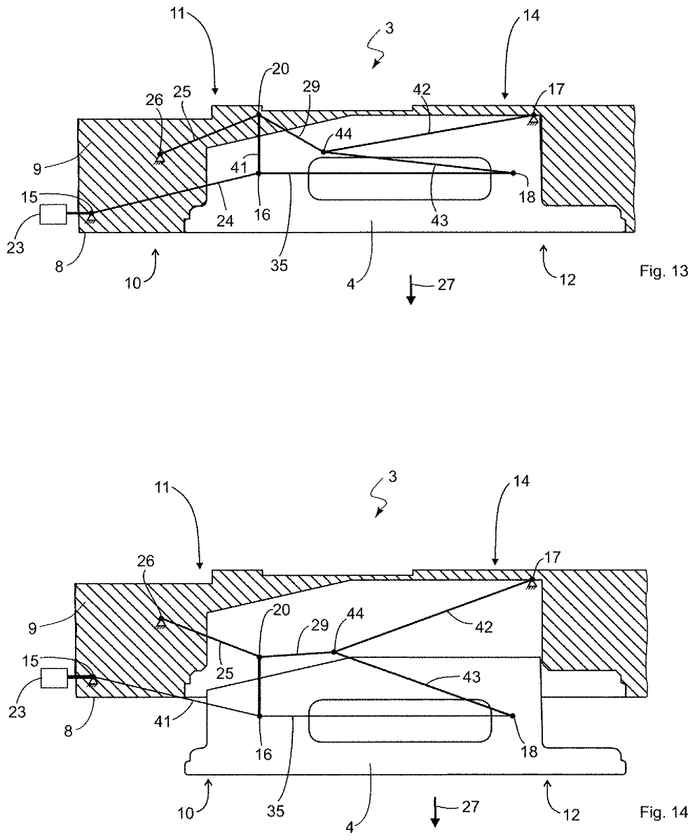

FIG. 12 is a schematic plan view of the door handle assembly according to the third embodiment of the invention, in which the handle is arranged in the actuation position,

FIG. 13 is a schematic top view of a door handle assembly according to a fourth embodiment of the invention, in which the handle is arranged in the non-use position, and

FIG. 14 is a schematic plan view of the door handle assembly according to the fourth embodiment of the invention, in which the handle is arranged in the actuation position.

FIG. 1 shows a vehicle or motor vehicle 1 in the form of a car by way of example having four doors 2 in the example (two of which can be seen in FIG. 1), which can be opened via a door handle assembly 3 and in particular with the aid of a handle 4. With reference to FIGS. 1 to 3, the doors 2 are closed by respective door locks 5 and can be opened from the outside by a respective actuation of the handle 4. The handle 4 is actuated to open the door lock 5, the actuation in the exemplary embodiments shown in the drawings being a pulling force exerted by the user on the handle 4. To open the door 2, the handle 4 is then either pulled in normal operation or the handle 4 is pivoted to a specific degree, whereby a switch is actuated, which in turn activates an electromechanical locking system 6 (see FIG. 4), with the aid of which the door lock 5 can then be opened electrically. When the handle 4 is actuated to electrically open the door lock 5, the handle 4 is moved out of an actuation position. The electrical opening can take place before attainment of the end position of the handle 4. In the case of a current-operated normal operation, a slight pulling movement on the handle 4 is consequently sufficient for a Bowden cable system 7, which is shown in FIG. 1 by way of example, to be operated electrically for unlocking the door lock 5. In the case of a currentless emergency operation, the door handle assembly 3 can be formed such that manual unlocking of the door lock 5 and thereby manual opening of the vehicle door 2 is possible by actuation of the handle 4 effected by a user, wherein the handle 4 must be deflected or actuated past the deflection which is necessary in the normal operation. FIG. 2 is a perspective view of one of the vehicle doors 2 and the handle 4 which serves for the opening of the vehicle door 2. In FIG. 2, the handle 4 is arranged approximately flush with the outer contour 8 of the vehicle door 2, i.e. flush with the edge, when the door handle assembly 3 is installed in the vehicle door 2. In this position the handle 4 is in a non-use position in which it is not used. From the non-use position shown in FIG. 2, it is possible to transfer the handle 4 to an actuation position shown in FIG. 3 in which it protrudes compared to the outer contour 8 of the vehicle door 2, such that the handle 4 is arranged in its actuation position to protrude from the vehicle door 2. In this protruding actuation position or extended actuation position from the outer contour 8, a user can reach behind and actuate or manipulate the handle 4 in order to open the vehicle door 2 or to unlock the vehicle-side door lock 5. According to the present invention, the handle 4 is transferred from the non-use position into the actuation position in a current-operated normal operation by means of a suitable drive means, wherein for the current-operated normal operation, proximity sensors or other sensors may be provided to move the handle 4 from the flush or flush-mounted non-use position to the actuation position as soon as a user approaches the door handle assembly 3 or handle 4. It can be seen from FIG. 3 that the handle 4 arranged in its actuation position is arranged on the outside on the door 2 of the motor vehicle 1, wherein the handle 4 can be gripped from behind by a user. The handle 4 is thus arranged so as to protrude relative to the outer contour 8 of the vehicle door 2 in the actuation position in comparison to the non-use position and can be actuated by the user in order to open the vehicle door 2. To couple the handle 4 to the vehicle door 2, a frame-like handle support 9 is provided, which is only shown schematically and in dashed lines in FIG. 3, since it is arranged on the inside of the vehicle door 2 and thus covered by the vehicle door 2 in FIGS. 1 and 2. The handle support 9 is secured to the inside of the vehicle door 2 via known securing means and supports the handle 4. In other words, the handle support 9, which can be secured to the vehicle door 2, is known to be used for attaching and mounting the handle 4 and is secured to the inside of the door 2 by means of screw connections (not shown in detail).

FIGS. 5 to 14 show different embodiments of the door handle assembly 3 according to the invention, wherein FIGS. 5 and 6 show a first embodiment, FIGS. 7 and 8 show a second embodiment, FIGS. 9 and 10 show an alternative to the second embodiment, FIGS. 11 and 12 show a third embodiment and FIGS. 13 and 14 show a fourth embodiment. All three embodiments have in common that a first longitudinal end 10 of the handle 4 mounted on the handle support 9 is coupled to a first lever mechanism 11 which is arranged on the first longitudinal end 10 so as to transmit a movement. A second lever mechanism 14 is arranged on a second longitudinal end 12 of the handle 4. In all three embodiments, the first lever mechanism 11 has a first pivot axis 15, which is arranged in a stationary manner on the handle support 9, the first pivot axis 15 alternatively also being able to be arranged on the vehicle door 2. Due to the fixed attachment to the handle support 9 or alternatively to the vehicle door 2, the mechanical symbol of a fixed bearing is used for the first pivot axis 15 in the drawings. Furthermore, the first lever mechanism 11 has a first joint axis 16 which is arranged at the first longitudinal end 10 of the handle 4 and which is coupled to the first pivot axis 15 so as to transmit a movement. The first joint axis 16 is mounted on the handle 4, so that the first joint axis 16 is moved with the handle 4 when the handle 4 moves from the non-use position into the actuation position. Furthermore, in all four embodiments, the second lever mechanism 14 has a second pivot axis 17, which is arranged fixed on the handle support 9 or alternatively on the vehicle door 2, which is why a fixed bearing is used as an example as a mechanical symbol for the second pivot axis 17 in the drawings. The second lever mechanism 14 also includes a second joint axis 18 which is arranged at the second longitudinal end 12 of the handle 4 and which is moved with the handle 4 when the handle 4 is moved. In all the embodiments shown in the drawings, the first pivot axis 15 is driven by a motor for moving the handle 4, which can be done, for example, by an electromotive drive element 23. In all four embodiments, the first lever mechanism 11 also has a lever element 19 which comprises a point of rotation 20. The lever element 19 has a first lever arm 21 and a second lever arm 22 and is rotatable with the first and second lever arms 21, 22 about the point of rotation 20. In addition, the lever element 19 in all four embodiments is designed to be coupled both to the first pivot axis 15 and to the first joint axis 16 so as to transmit a movement.

With reference to the first embodiment of the door handle assembly 3 shown in FIGS. 5 and 6, the first lever mechanism 11 furthermore has a movement lever 24 mounted on the first pivot axis 15 and a guide lever 25. The guide lever 25 is mounted on a third pivot axis 26, the third pivot axis 26 being arranged on the handle support 9. Alternatively, the third pivot axis 26 can also be arranged on the vehicle door 2. As can be seen from FIGS. 5 and 6, the third pivot axis 26 is arranged offset to the first pivot axis 15 in an opening direction 27 of the handle 4, Furthermore, the movement lever 24 and the guide lever 25 are arranged so as to be offset parallel to one another such that the guide lever 25 is connected in art articulated manner to the first lever arm 21 and the movement lever 24 is connected in an articulated manner to the point of rotation 20. The first lever arm 21 and the second lever arm 22 are arranged at the point of rotation 20 at an acute angle 28 to one another. The second lever arm 22 connects or couples the point of rotation 20 and the first joint axis 16 to one another. In the first embodiment, the first joint axis 16 is coupled to the second joint axis 18 with the aid of a coupling rod 29 so as to transmit a movement, wherein an active lever 30 couples the second joint axis 18 to the second pivot axis 17. The second longitudinal end 12 of the handle 4 is connected to the handle support 9 via the active lever 30 and the second pivot axis 17 and is guided when the handle 4 moves. To move the handle 4 from the non-use position into the actuation position, the movement lever 24 pivots in the opening direction 27, wherein the movement lever 24 presses the lever element 19 in the opening direction 27. The lever element 19 presses the coupling rod 29 and the first joint axis 16 likewise in the opening direction 27 of the handle 4, wherein the coupling rod 29 which is pressed in the opening direction 27 presses the second joint axis 18 in the opening direction 27, such that the handle 4 is arranged in its actuation position.

FIGS. 7 and 8 show a second embodiment of the door handle assembly 3 according to the invention, wherein FIGS. 9 and 10 show an alternative modification of the second embodiment. With reference to FIGS. 7 to 10, in the second embodiment the first lever arm 21 of the lever element 19 is coupled to the first pivot axis 15. Furthermore, the coupling rod 29 is rotatably mounted on the second lever arm 22 of the lever element 19. The coupling rod 29 is connected to the second joint axis 18 in an articulated manner. In contrast to the first embodiment, a lever-like coupling element 31 is provided in the second embodiment, which is rotatably mounted on the point of rotation 20. The coupling element 31 has a first coupling arm 32 and a second coupling arm 33. The first coupling arm 32 is connected in an articulated or rotatable manner to the first joint axis 16, whereas the second coupling arm 33 is coupled to the second pivot axis 17 so as to transmit a movement. This movement coupling is realized with the aid of a pivot lever 34 which is rotatably mounted on the second pivot axis 17. The pivot lever 34 connects the second pivot axis 17 and the second coupling arm 33 of the coupling element 31 to one another. As can be seen from FIGS. 7 and 8 and FIGS. 9 and 10, the lever element 19 and the coupling element 31 can be pivoted relative to one another when the handle 4 is moved from the non-use position into the actuation position. In the second embodiment shown in FIGS. 7 and 8, the first lever arm 21 is longer (i.e. with a greater longitudinal extension) than the second lever arm 22, wherein the first coupling arm 32 is designed to be longer than the second lever arm 22 and the second coupling arm 33 is designed to be longer than the first lever arm 21. In contrast to this, in the alternative shown in FIGS. 9 and 10, the first lever arm 21 and the second lever arm 22 are of equal length, the first coupling arm 32 being shorter than the first lever arm 21 and the second coupling arm 33 being longer than the first lever arm 21. In the embodiments shown in FIGS. 7 to 10, a stabilizing rod 35 is provided between the first joint axis 16 and the second joint axis 18. The stabilizing rod 35 is only optional and therefore unnecessary in the second embodiment and its alternative.

FIGS. 11 and 12 show the third embodiment of the door handle assembly 3 according to the invention. In this embodiment, the lever element 19 is mounted with its point of rotation 20 on the first pivot axis 15 and connected in a rotationally fixed manner to the first pivot axis 15, such that the driven pivot axis 15 rotates the lever element 19 about the point of rotation or about the first pivot axis 15. The first lever arm 21 of the lever element 19 is connected in an articulated manner to the first joint axis 16, whereas the second lever arm 22 is connected in an articulated manner to the coupling rod 29. Furthermore, the second lever mechanism 14 in this third embodiment has a pivot lever element 36. The pivot lever element 36 is identical to the lever element 19 and has a first pivot lever arm 37 and a second pivot lever arm 38. The first pivot lever arm 37 is connected to the second joint axis 18 in an articulated manner, whereas the second pivot lever arm 38 is connected to the second lever arm 22 via a first coupling rod 39 in an articulated manner. Furthermore, the first joint axis 16 is connected to the second joint axis 18 via a second coupling rod 40 in an articulated manner, wherein the lever element 19 of the first lever mechanism 11 and the pivot lever element 36 of the second lever mechanism 14 are of identical design, such that the first lever arm 21 has an identical length as the first pivot lever arm 37 and the second lever arm 22 has an identical length as the second pivot lever arm 38. With the aid of this configuration, when the handle 4 is moved from the non-use position into the actuation position, the pivoting direction of the lever element 19 about the first pivot axis 15 is the same as that of the pivot lever element 36 about the second pivot axis 17. The lever element 19 is consequently not only identical to the pivot lever element 36, but the lever element 19 and the pivot lever element 36 also move synchronously when the handle 4 is moved. The first coupling rod 39 and the second coupling rod 40 extend parallel to one another, wherein the distance between the first coupling rod 39 and the second coupling rod 40 is greater in the actuation position of the handle 4 than in the non-use position of the handle 4, as is shown in the comparison of FIGS. 11 and 12.

FIGS. 13 and 14 finally show the fourth embodiment of the door handle assembly 3 according to the invention. In the fourth embodiment, the first lever mechanism 11 in turn (as in the first embodiment) has a third pivot axis 26. As in the first embodiment, it is also provided here that a guide lever 25 is pivotably mounted on the third pivot axis 26. This guide lever 25 is connected in an articulated manner to a connecting lever 41 which is secured to the handle 4 via a point of rotation 20. The guide lever 25 couples the third pivot axis 26 to the first joint axis 16, wherein the connecting lever 41 couples the guide lever 25 and a movement lever 24 which is pivotably mounted on the first pivot axis 15. Furthermore, the second lever mechanism 14 has a first coupling lever 42 and a second coupling lever 43. The first coupling lever 42 is mounted on the second pivot axis 17, whereas the second coupling lever 43 is mounted on the second joint axis 18. The first coupling lever 42 and the second coupling lever 43 are interconnected at an articulation point 44 in an articulated manner, wherein the joint point 44 is connected to the connecting lever 41 via a coupling rod 29. When the handle 4 moves from the non-use position into the actuation position, the drive element 23 thus drives the first pivot axis 15, to which the guide lever 25 is connected in a rotationally fixed manner, so that the guide lever 25 rotates clockwise in the opening direction 27 of the handle 4. The guide lever 25 presses the connecting lever 41 in the opening direction 27, whereby the coupling rod 29 simultaneously displaces the joint point 44 in the opening direction 27. A stabilizing rod 35, which connects the first joint axis 16 to the second joint axis 18, then ensures, among other things, that the second longitudinal end 12 of the handle 4 is moved synchronously with the first longitudinal end 10 of the handle 4 in the opening direction 27.

The invention described above is, of course, not limited to the embodiments described and depicted. It is evident that numerous modifications can be made to the embodiments shown in the drawing, which are obvious to the person skilled in the art according to the intended application, without leaving the scope of the invention. The invention includes everything that is contained in the description and/or depicted in the drawing, including anything that, deviating from the concrete design examples, is obvious to the person skilled in the art.

1. Door handle assembly of a vehicle door, having a handle support which can be secured to the vehicle door, a handle being mounted on the handle support and arranged so as to run flush with the outer contour of the vehicle door in a non-use position and being designed to be movable into an actuation position by a user for actuation, and a first lever mechanism which is coupled to the first longitudinal end of the handle so as to transmit a movement, and a second lever mechanism which is arranged on the second longitudinal end of the handle,
wherein the handle is arranged so as to protrude relative to the outer contour of the vehicle door in the actuation position in comparison to the non-use position and can be actuated by the user in order to open the vehicle door, and
wherein the first lever mechanism has a first pivot axis which is arranged on the handle support,
wherein the second lever mechanism has a second pivot axis which is coupled to the first lever mechanism so as to transmit a movement, wherein the first lever mechanism and the second lever mechanism are designed to be coupled to one another in the manner of a multi-joint kinematic system so as to transmit a movement, and the first longitudinal end and the second longitudinal end of the handle are designed to simultaneously extend out of the outer contour.

2. Door handle assembly according to claim 1, wherein the first lever mechanism has a first joint axis which is arranged at the first longitudinal end of the handle and which is coupled to the first pivot axis so as to transmit a movement, wherein the second lever mechanism has a second pivot axis which is arranged on the handle support and a second joint axis which is arranged on the second longitudinal end of the handle, and wherein the first pivot axis is motor-driven to move the handle.

3. Door handle assembly according to claim 2, wherein the first lever mechanism has a lever element having a point of rotation with a first lever arm and a second lever arm, wherein the lever element is designed to be coupled both to the first pivot axis and to the first joint axis so as to transmit a movement.

4. Door handle assembly according to claim 3, wherein the first lever mechanism further comprises a movement lever mounted on the first pivot axis and a guide lever (25), wherein the guide lever is mounted on a third pivot axis which is arranged on the handle support, wherein the third pivot axis is offset from the first pivot axis in an opening direction of the handle, and wherein the movement lever and the guide lever are arranged to be offset parallel to one another such that the guide lever is connected in an articulated manner to the first lever arm and the movement lever is connected in an articulated manner to the point of rotation.

5. Door handle assembly according to claim 4, wherein the first lever arm and the second lever arm are arranged at the point of rotation at an acute angle (x) to one another, wherein the second lever arm connects the point of rotation and the first joint axis to one another.

6. Door handle assembly according to claim 5, wherein a coupling rod couples the first joint axis to the second joint axis so as to transmit a movement, wherein an active lever couples the second joint axis to the second pivot axis.

7. Door handle assembly according to claim 6, wherein the movement lever is pivoted in the opening direction and thereby the movement lever, the lever element, and the coupling rod press the second joint axis in the opening direction to move the handle from the non-use position into the actuation position.

8. Door handle assembly according to claim 3, wherein the first lever arm is coupled to the first pivot axis and a coupling rod is rotatably mounted on the second lever arm and is connected to the second joint axis in an articulated manner, wherein a coupling element is provided which is rotatably mounted on the point of rotation and which has a first coupling arm which is rotatably connected to the first joint axis and a second coupling arm which is coupled to the second pivot axis so as to transmit a movement.

9. Door handle assembly according to claim 8, wherein a pivot lever rotatably mounted on the second pivot axis connects the second pivot axis and the second coupling arm to one another.

10. Door handle assembly according to claim 9, wherein the lever element and the coupling element are pivotable relative to one another.

11. Door handle assembly according to claim 8, wherein the first lever arm is longer than the second lever arm, wherein the first coupling arm is designed to be longer than the second lever arm and the second coupling arm is designed to be longer than the first lever arm.

12. Door handle assembly according to claim 8, wherein the first lever arm and the second lever arm are of equal length, wherein the first coupling arm is designed to be shorter than the first lever arm and the second coupling arm is designed to be longer than the first lever arm.

13. Door handle assembly according to claim 3, wherein the lever element is mounted on the first pivot axis with its point of rotation, wherein the first lever arm is connected to the first joint axis in an articulated manner and the second lever mechanism comprises a pivot lever element having a first pivot lever arm which is connected to the second joint axis and a second pivot lever arm which is connected to the second lever arm via a first coupling rod in an articulated manner.

14. Door handle assembly according to claim 13, wherein the first joint axis is connected to the second joint axis via a second coupling rod in an articulated manner, wherein the lever element of the first lever mechanism and the pivot lever element of the second lever mechanism are of identical design, such that the first lever arm has an identical length as the first pivot lever arm and the second lever arm has an identical length as the second pivot lever arm.

15. Door handle assembly according to claim 14, wherein when the handle is moved from the non-use position into the actuation position, the pivoting direction of the lever element about the first pivot axis is the same as that of the pivot lever element about the second pivot axis.

16. Door handle assembly according to claim 2, wherein the first lever mechanism has a third pivot axis on which a guide lever is pivotally mounted, which in turn is connected to a connecting lever fastened to the handle in an articulated manner, wherein the guide lever couples the third pivot axis to the first joint axis and the connecting lever couples the guide lever and a movement lever which is pivotally mounted on the first pivot axis.

17. Door handle assembly according to claim 16, wherein the second lever mechanism has a first coupling lever which is mounted on the second pivot axis and a second coupling lever which is mounted on the second joint axis, wherein the first coupling lever and the second coupling lever are interconnected in an articulated manner at a joint point which is connected to the connecting lever via a coupling rod.
